(19) United States
(12) Patent Application Publication
(10) Pub. No.: US 2005/0018351 A1
(43) Pub. Date: Jan. 27, 2005

(54) Spindle motor for hard disk drives having an axially attached bearing system

(75) Inventors: Joerg Hoffmann, Mettlach (DE); Ljubomir Francuski, Spaichingen (DE); Milena Francuski, Spaichingen (DE); Thilo Rehm, Villingen-Schwenningen (DE)

Correspondence Address: SCHULTE ROTH & ZABEL LLP;ATTN: JOEL E. LUTZKER, 919 THIRD AVENUE, NEW YORK, NY, 10022, US

(73) Assignee: Minebea Co., Ltd., Nagano-Ken (JP)

(21) Appl. No.: 10/863,040

(22) Filed: Jun. 8, 2004

(30) Foreign Application Priority Data
Nov. 25, 2002 (WO) PCT/EP02/13196
Dec. 12, 2001 (DE) 101 60 857.8

(51) Int. Cl. G11B 5/48

(52) U.S. Cl. 360/240

(57) ABSTRACT

A spindle motor for hard disk drives having a base-plate, a stator, a rotor, a shaft, a bearing recess formed in either the rotor or the base-plate; and an upper roller bearing and a lower roller bearing. Each roller bearing includes an inner ring and an outer ring. Inner rings are fixedly mounted on the shaft. At least one outer ring is secured to the bearing recess by welding or bonding at predetermined spots located at a first end face of the outer ring. The outer ring is secured to the bearing recess without applying an adhesive between an outer perimeter of the outer ring and the inner wall of the bearing recess.

### CROSS REFERENCE TO RELATED APPLICATION

This application claims all rights of priority to PCT Application No. PCT/EP02/13196, filed Nov. 25, 2002 (pending), which in turn claims all rights of priority to German Patent Application No. 101 60 857.8, filed Dec. 12, 2001 (pending).

### FIELD OF THE INVENTION

The invention relates to a spindle motor for hard disk drives.

### BACKGROUND

As a rule, spindle motors for hard disk drives spindle motors include a base-plate with a stator mounted thereon, a shaft and one or more roller bearings for a rotational support of a rotationally powered rotor. For this purpose, one end of the shaft can be firmly connected to the base-plate such that the rotor is supported rotatably with respect to the shaft and the base-plate. On the other hand, the shaft can be attached firmly to the rotor such that both the shaft and the rotor rotate with respect to the base-plate.

A disadvantage of described spindle motors, particularly if they are used to power hard disk drives, lies in the fact that it is relatively difficult to precisely align and secure the roller bearing. To fix the bearing rings, i.e. the inner and outer rings, it has previously been known to use an adhesive. For this purpose, the adhesive is applied to the outer radial perimeter of the outer ring which is then bonded to a bearing recess provided in the rotor or the base-plate.

Adhesive is also applied to the inner perimeter of the inner rings which are then bonded to the shaft. This process can result in the deformation of the bearing rings after the adhesive has hardened since the adhesive is sometimes applied unevenly or hardens at different rates causing the bearing rings to become distorted. The bearing rings then deviate from their ideal cylindrical shape. This distortion is particularly critical where the outer rings are concerned and can lead to significant deterioration in the characteristics of the bearing which is manifested, for example, in an unevenly running motor and in an increase in the noise level.

### BRIEF SUMMARY

It is an object of the invention to improve the above-mentioned spindle motor in such a way as to prevent deformation of the roller bearings' rings in their mounted state.

In accordance with the preferred embodiment of the invention, the bearing system is only fixed axially in the bearing recess around the bearing edges of at least one of its outer rings. Thus, the full surface of the outer ring is not bonded to the respective component of the spindle motor. The outer ring is accommodated in the bearing recess by means of a fit, preferably a transition fit, and fixed at its end face. Using the same method, the inner rings of the bearing arrangement can be immovably fixed to the shaft in the correct positional arrangement.

In accordance with the first preferred embodiment of the invention, the bearing recess is formed in the rotor such that the end face of at least one outer ring of the bearing system is attached to the rotor. The end face of the other outer ring can rest against an axial contact surface of the rotor or be additionally fixed to the rotor by some appropriate means. If a bearing system has only one common outer ring then the method will be adjusted accordingly.

In another embodiment of the invention, the bearing recess is formed in the base-plate such that the end face of at least one outer ring of the bearing system is fixed to the base-plate. The end face of the other outer ring can rest against an axial contact surface of the base-plate or be fixed to the base-plate by other appropriate means. If a bearing system has only one common outer ring then the method will be adjusted accordingly.

According to the invention, the inner rings of the bearing system can also be immovably fixed to the shaft in an axial direction only at their end faces. However, they can also be attached by any other conventional means with their entire inner surface being connected to the shaft.

The axial attachment of the bearing system according to the method of the present invention produces no undesirable distortion of the bearing rings that occurs when the outside perimeter of the outer ring is bonded to the rotor or the base-plate and/or the inside perimeter of the inner ring is bonded to the shaft.

The outer ring can be fixed in the bearing recess by welding or bonding, by using a retaining or mounting ring or by caulking. The important factor here is that the outer ring of the bearing system is only attached in an axial direction and that no radial adhesive forces act on the bearing system.

The subject matter of this invention is not only derived from the subject matter of the individual patent claims, but also from the combination of the individual patent claims with each other. All particulars and characteristics revealed in the documents, including the abstract and particularly the three-dimensional design illustrated in the drawings, are claimed as being essential to the invention to the extent that, either individually or in combination, they represent an innovation in respect of the prior art.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a cross-sectional view of a first embodiment of a spindle motor having a stationary shaft and an axially attached bearing system;

FIG. 2 is a cross-sectional view of a second embodiment of a spindle motor having a stationary shaft and an axially attached bearing system;

FIG. 3 is a cross-sectional view of a third embodiment of a spindle motor having a stationary shaft and an axially attached bearing system;

FIG. 4 is a cross-sectional view of a fourth embodiment of a spindle motor having a stationary shaft and an axially attached bearing system;

FIG. 5 is a cross-sectional view of a fifth embodiment of a spindle motor having a stationary shaft and an axially attached bearing system;

FIG. 6 is a cross-sectional view of a sixth embodiment of a spindle motor having a stationary shaft and an axially attached bearing system;

FIG. 7 is a cross-sectional view of a first embodiment of a spindle motor having a rotating shaft and an axially attached bearing system;

FIG. 8 is a cross-sectional view of a second embodiment of a spindle motor having a rotating shaft and an axially attached bearing system; and

FIG. 9 is a cross-sectional view of an alternative embodiment of a spindle motor having a stationary shaft and an axially attached bearing system.

### DETAILED DESCRIPTION

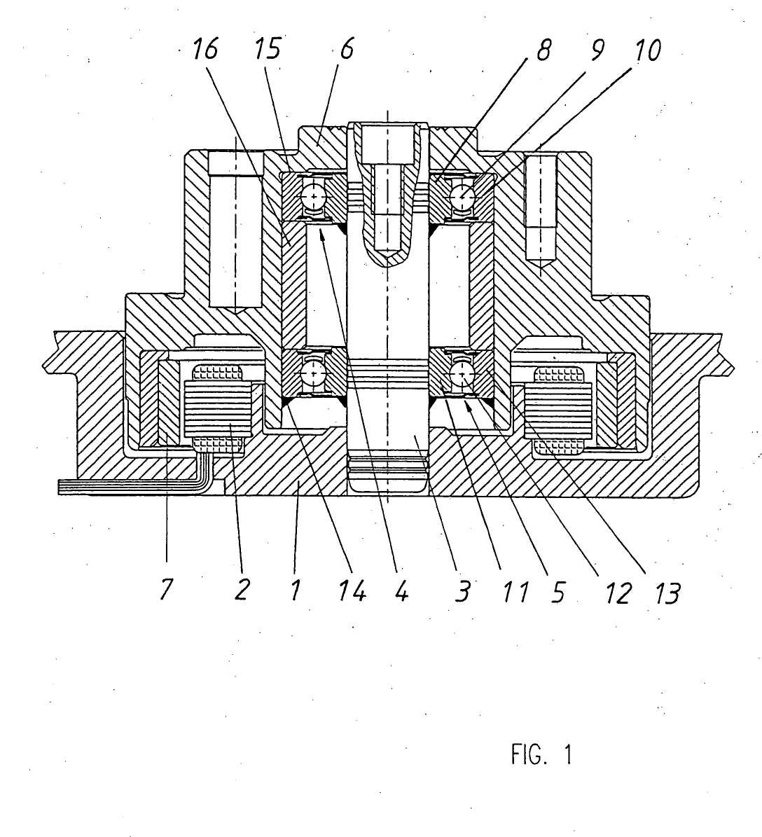

In the embodiments provided as an example, the axial attachment of the is bearing system as presented in the invention is preferably described using the area of the outer rings of the bearing since it is here that the positive effects of the invention on the way the motor runs are the most apparent. The inner rings can be attached to the perimeter of the shaft using a conventional method or they can also feature an attachment in an axial direction in accordance with the invention. This is indicated in FIG. 1.

The spindle motor presented in FIG. 1 includes a stationary baseplate 1 to which a shaft 3 is firmly connected. A rotor 6 is rotatably connected to the shaft 3 by an upper roller bearing 4 and a lower roller bearing 5 and features appropriate permanent magnets 7 on its inner perimeter which are exposed to an alternating electrical field generated by a stator 2 arranged on the baseplate 1.

The roller bearings 4, 5 are accommodated in a bearing recess which is formed at the central inner portion of the rotor 6. The upper roller bearing 4 includes an inner ring 8 connected firmly to the shaft 3, an outer ring 10 connected firmly to the rotor 6 and roller elements 9 arranged between the inner ring 8 and outer ring 10. The lower roller bearing 5, correspondingly, includes an inner ring 11 connected firmly to the shaft 3, an outer ring 13 connected firmly to the rotor and roller elements 12 arranged between the inner ring 11 and the outer ring 13.

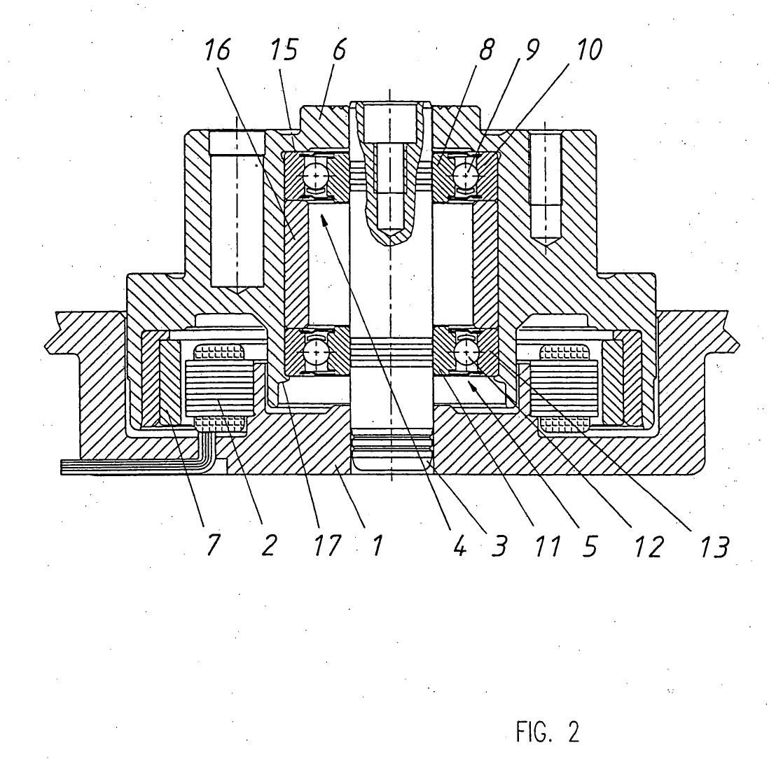

The characteristics mentioned above are essentially common to all the embodiments shown in FIGS. 1 to 5 and will not be specifically described again in connection with FIGS. 2 to 5.

In the embodiment according to FIG. 1, the upper end face of the upper outer ring 10 rests against a contact surface 15 of the rotor. A spacer 16 is arranged between the upper and lower roller bearing 4 and 5. The lower outer ring 13 rests against the other end of the spacer 16 and is attached to the rotor 6 by welding or bonding at spots 14 at its lower end face. As indicated in FIG. 1, inner rings 8, 11 can also be attached to the shaft by welding or bonding at appropriate spots.

In the embodiment shown in FIG. 2, the bearing system is fixed at the lower end face of the lower outer ring 13 by means of a projection 17. Projection 17 is formed after the bearing system is assembled within the rotor by deforming the inner surface of the rotor 6 using stamping or a similar process.

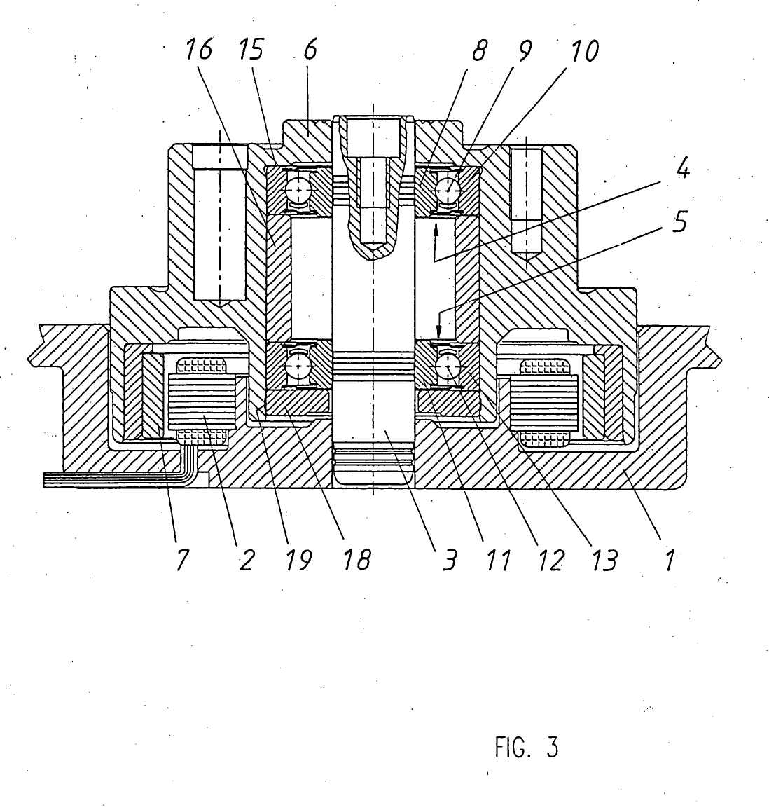

FIG. 3 shows an embodiment in which the bearing system is fixed at the lower end surface of the lower outer ring 13 by a mounting ring 18. The mounting ring 18 may be bonded to the walls of the bearing recess, effectively attaching it to the rotor 6 at the bond spot 19.

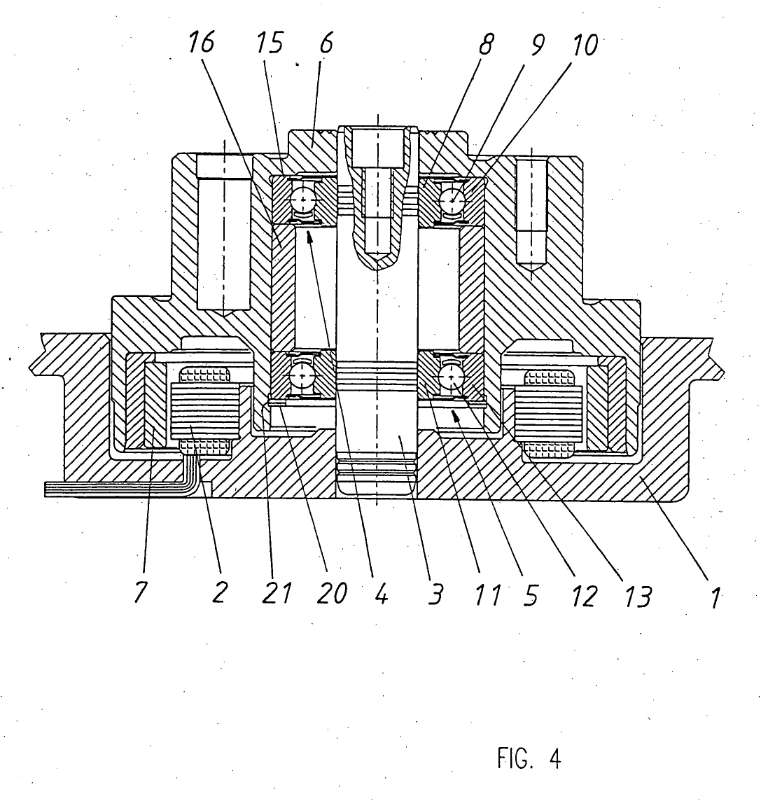

An embodiment is shown in FIG. 4, in which a retaining ring 20 is used for the axial attachment of the bearing system. The retaining ring 20 is set into a groove 21 in the rotor 6 and presses against the end face of the lower outer ring 13 such that the entire bearing system is held in position by the retaining ring.

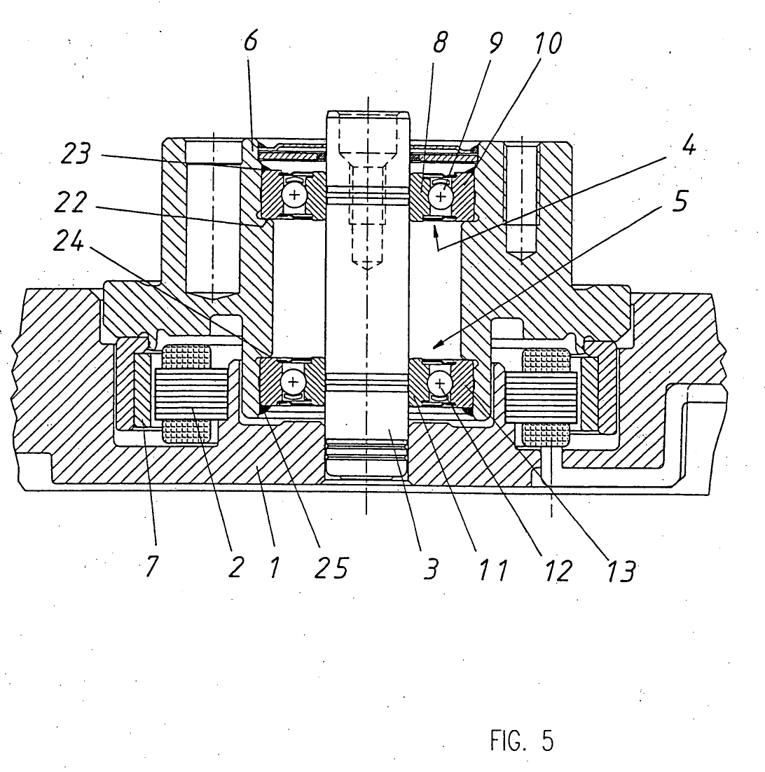

Finally, FIG. 5 shows an embodiment in which no spacer is used between the roller bearings 4, 5. Instead, the lower end face of the roller bearing outer ring 8 and the upper end face of the roller bearing outer ring 13 are positioned against projections 22 or 24, respectively, formed on the inner surface of the rotor 6. Outer rings 8 and 13 are fixed to the rotor 6 in this position by welding or bonding at spots 23 or 25 applied to the end face of each outer ring opposite the end face placed against the rotor projection.

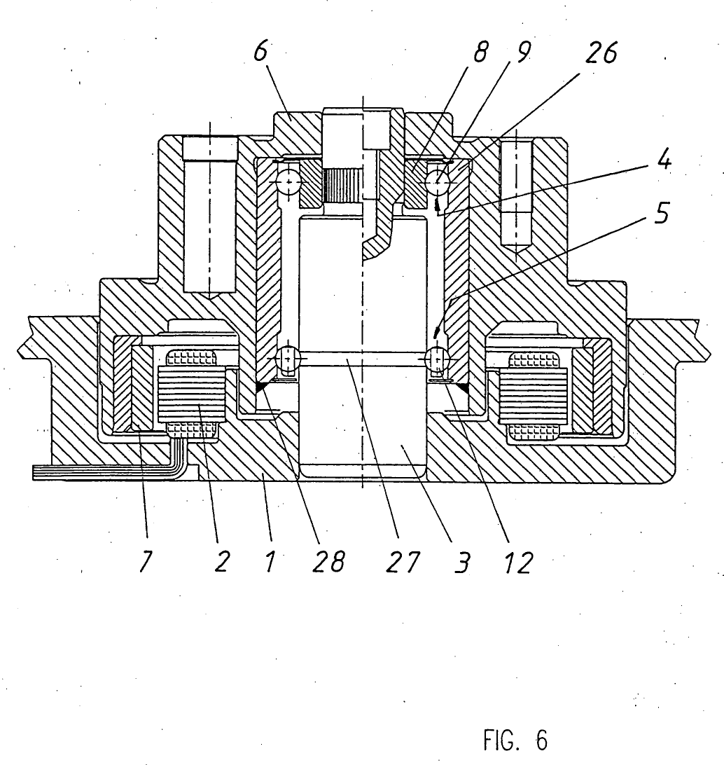

In the illustration shown in FIG. 6, both roller bearings 4, 5 feature a common outer ring 26 which is fixed to the rotor by welding or bonding at several spots 28 applied to one end face of the outer ring 26. The upper roller bearing 4 has an inner ring 8 attached to the shaft 3, while the inner bearing surface for roller elements 12 of the lower bearing 5 is formed by a groove 27 provided at the outer perimeter of the shaft 3.

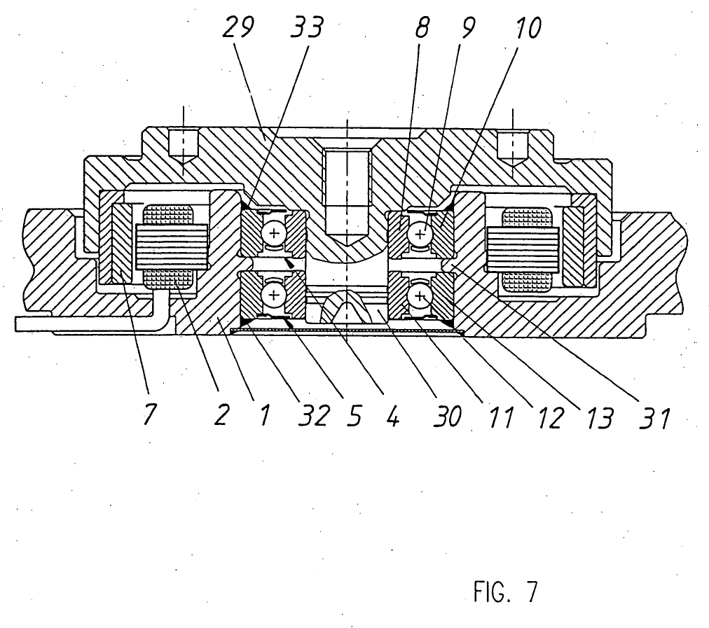

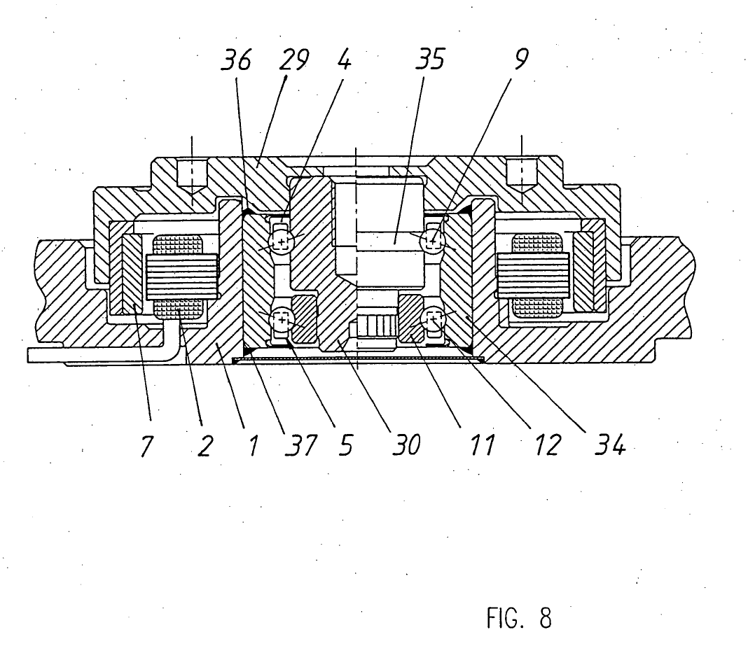

FIGS. 7 and 8 show spindle motors with a rotating shaft 30, i.e. the shaft is connected to the rotor 29 and rotates together with it. The bearing recess is formed within the base-plate 1.

According to FIG. 7, the shaft 30 is formed as one piece with the rotor and is supported by two roller bearings 4 and 5. Lower end face of the outer ring 10 and the upper end face of the outer ring 13 of the two roller bearings 4, 5 rest against an annular projection 31 formed on the inner cylindrical surface of the base-plate 1. The other end face of each outer ring is fixed in the axial direction by bonding or welding at spots 32 and 33.

In FIG. 8, a separate shaft 30 connected firmly to the rotor 29 is illustrated. Two roller bearings 4, 5 feature a common outer ring 34, which is axially fixed in the bearing recess by bonding or welding its end faces at spots 36, 37.

The inner bearing surface of the upper roller bearing 4 is formed by an annular groove 35 provided in the shaft 30. The lower roller bearing 5 has an inner ring 11 connected to the shaft 30.

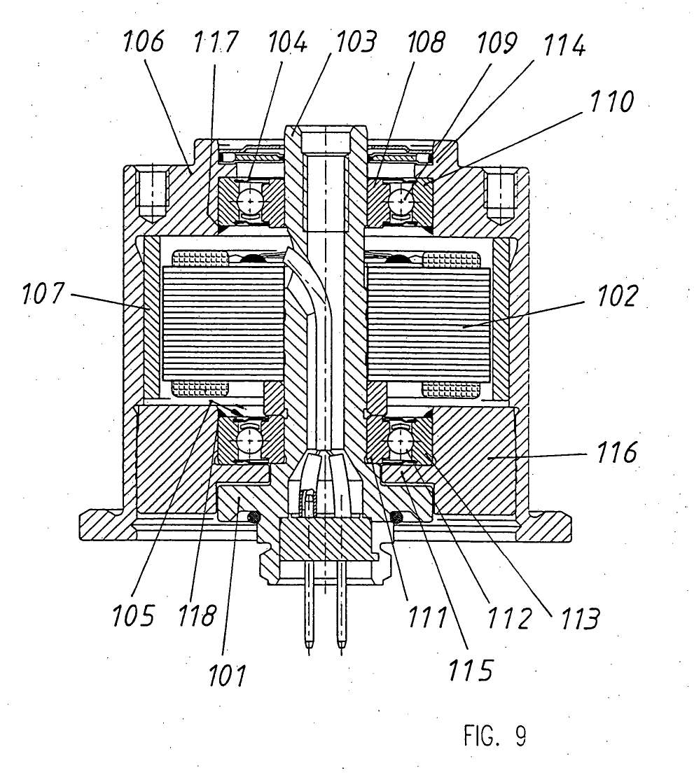

Finally, another variation of a spindle motor having a stationary shaft 103 is shown in FIG. 9.

Shaft 103 is formed on a stationary base 101. A bell-shaped rotor 106 is rotatably supported on the shaft 103 by an upper roller bearing 104 and a lower roller bearing 105 and features appropriate permanent magnets 107 at its inner perimeter. Magnets 107 are exposed to an alternating electrical field generated by a stator 102 arranged on the shaft 103, between the roller bearings 104, 105.

Roller bearings 104, 105 are accommodated in a bearing recess which is formed at the central inner portion of the rotor 106. The upper roller bearing 104 includes an inner ring 108 firmly connected to the shaft 103, an outer ring 110 connected firmly to the rotor and roller elements 109 arranged between the inner ring 108 and the outer ring 110. The lower roller bearing 105, correspondingly, includes an inner ring 111 firmly connected to the shaft, an outer ring 113 firmly connected to the rotor and roller elements 112 arranged between the inner ring 111 and the outer ring 113.

In the shown preferred embodiment, upper end face of the outer ring 110 and the bottom end face of the outer ring 113 of the two roller bearings 104, 105 rest on a dedicated radial projection. Projection 114 dedicated to the upper outer ring 110 is formed on the inner surface of the rotor 106, while the projection 115 dedicated to the lower outer ring 113 is formed on the inner surface of an end ring 116. Outer rings 110, 113 are again fixed in their axial position by bonding or welding the other end face of each outer ring at spots 117, 118.

The methods of attaching the bearing system and the bearing system embodiments mentioned and illustrated in the figures can be swapped and combined in any way desired. In the context of the invention, the means of attaching the bearing system plays a subordinate role. All known means can be used provided that they act on the bearing system in an axial direction in a manner which accords with the invention.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

1. A spindle motor for hard disk drives comprising:
a base-plate;
a stator;
a rotor;
a shaft;
a bearing recess formed in one of said rotor and said base-plate; and
an upper roller bearing and a lower roller bearing, each of said roller bearings having an inner ring and an outer ring;
wherein said inner rings are fixedly mounted on said shaft, wherein at least one of said outer rings is secured to said bearing recess by one of welding or bonding at predetermined spots located at a first end face of said at least one outer ring, and wherein said at least one outer ring is secured to said bearing recess without applying an adhesive between an outer perimeter of said at least one outer ring and said bearing recess.

2. The spindle motor according to claim 1 further comprising a spacer placed between said upper roller bearing and said lower roller bearing such that one end face of said upper roller bearing and one end face of said lower roller bearing are positioned against said spacer.

3. The spindle motor according to claim 1 wherein said outer rings of said upper roller bearing and said lower roller bearing are formed as a single unitary element.

4. The spindle motor according to claim 1, wherein a second end face of said at least one outer ring rests on a contact surface formed at the inner perimeter of said bearing recess.

5. The spindle motor according to claim 1, wherein a second end face of said at least one outer ring rests on a projection formed at the inner perimeter of said bearing recess.

6. A spindle motor for hard disk drives comprising:
a base-plate;
a stator;
a rotor;
a shaft;
a bearing recess formed in one of said rotor and said base-plate; and
an upper roller bearing and a lower roller bearing, each of said roller bearings having an inner ring and an outer ring;
wherein said inner rings are fixedly mounted on said shaft, wherein at least one of said outer rings is secured to said bearing recess by annular supporting means positioned adjacently to an end face of said at least one outer ring, and wherein said at least one outer ring is secured to said bearing recess without applying an adhesive between an outer perimeter of said at least one outer ring and said bearing recess.

7. The spindle motor according to claim 6, wherein said annular supporting means is a retaining ring.

8. The spindle motor according to claim 6, wherein said annular supporting means is a mounting ring.

9. The spindle motor according to claim 6, wherein said outer rings of said upper roller bearing and said lower roller bearing are formed as a single unitary element.

10. The spindle motor according to claim 6, wherein a second end face of said at least one outer ring rests on a contact surface formed at the inner perimeter of said bearing recess.

11. The spindle motor according to claim 6, wherein a second end face of said at least one outer ring rests on a projection formed at the inner perimeter of said bearing recess.

12. A spindle motor for hard disk drives comprising:
a base-plate;
a stator;
a rotor;
a shaft;
a bearing recess formed in one of said rotor and said base-plate; and
an upper roller bearing and a lower roller bearing, each of said roller bearings having an inner ring and an outer ring;
wherein said inner rings are fixedly mounted on said shaft, wherein at least one of said outer rings is secured to said bearing recess by a projection formed on the surface of said bearing recess adjacently to an end face of said at least one outer ring, and wherein said at least one outer ring is secured to said bearing recess without applying an adhesive between an outer perimeter of said at least one outer ring and said bearing recess.

13. The spindle motor according to claim 12, wherein said projection on the surface of said bearing recess is formed by caulking.

14. The spindle motor according to claim 12 wherein said outer rings of said upper roller bearing and said lower roller bearing are formed as a single unitary element.

15. The spindle motor according to claim 12, wherein a second end face of said at least one outer ring rests on a contact surface formed at the inner perimeter of said bearing recess.

16. The spindle motor according to claim 12, wherein a second end face of said at least one outer ring rests on a projection formed at the inner perimeter of said bearing recess.
